(19) United States
(12) Patent Application Publication
(10) Pub. No.: US 2025/0142534 A1
(43) Pub. Date: May 1, 2025

(54) METHODS, DEVICES, AND COMPUTER READABLE MEDIUM FOR COMMUNICATION

(71) Applicant: NEC CORPORATION, Tokyo (JP)

(72) Inventors: Gang WANG, Beijing (CN); Yukai GAO, Beijing (CN)

(73) Assignee: NEC CORPORATION, Tokyo (JP)

(21) Appl. No.: 18/835,657

(22) PCT Filed: Feb. 10, 2022
(86) PCT No.: PCT/CN2022/075917

§ 371 Date: Aug. 2, 2024

(51) Int. Cl. H04W 72/02; H04L 1/00; H04L 1/1812; H04L 5/00

(52) U.S. Cl. CPC H04W 72/02; H04L 1/0016; H04L 1/1812; H04L 5/0053

(57) ABSTRACT

Embodiments of the present disclosure relate to methods, devices, and computer readable medium for communication. According to some embodiments, a method comprises determining, at a terminal device, that a negative acknowledgment (NACK) feedback is to be transmitted for at least one of a set of transport blocks (TBs) transmitted from a network device; selecting, from a mapping table associated with the set of TBs, a cyclic shift value mapped to a combination of the at least one TB; generating a sequence at least based on the selected cyclic shift value; and transmitting, to the network device, the NACK feedback for the at least one TB using the generated sequence.

### TECHNICAL FIELD

Embodiments of the present disclosure generally relate to the field of telecommunication, and in particular, to methods, devices, and computer readable medium for communication.

### BACKGROUND

To improve transmission reliability, a Hybrid Automatic Repeat Request (HARQ) mechanism has been widely used in communication systems. According to the HARQ mechanism, a receiver transmits HARQ feedback information to a transmitter to indicate whether a data transmission from the transmitter is detected successfully. Then, a transmitter performs a new transmission or a retransmission depending on whether the HARQ feedback indicates the data transmission is successfully detected or not.

Currently a terminal device can support a Multicast and Broadcast Service (MBS) in addition to a unicast service with a network device. According to the MBS mechanism, a terminal device may be configured into one or more multicast groups of terminal devices, and a network device may transmit one or more transport blocks (TBs) to a multicast group of terminal devices. At the side of a terminal device, it may need to carefully generate the HARQ feedback so as to indicate which TB(s) in which multicast group is or is not successfully detected.

### SUMMARY

In general, example embodiments of the present disclosure provide a solution for communication.

In a first aspect, there is provided a communication method. The method comprises: determining, at a terminal device, that a negative acknowledgment (NACK) feedback is to be transmitted for at least one of a set of transport blocks (TBs) transmitted from a network device; selecting, from a mapping table associated with the set of TBs, a cyclic shift value mapped to a combination of the at least one TB; generating a sequence at least based on the selected cyclic shift value; and transmitting, to the network device, the NACK feedback for the at least one TB using the generated sequence.

In a second aspect, there is provided a communication method. The method comprises: transmitting, at a network device, a set of transport blocks (TBs) to at least one multicast group of terminal devices; receiving, from a terminal device, a negative acknowledgment (NACK) feedback using a sequence, the terminal device being comprised in the at least one multicast group; decoding the sequence to obtain at least a cyclic shift value used for generating the sequence; determining, from a mapping table associated with the set of TBs, a combination of at least one TB mapped to the cyclic shift value; determining that the NACK feedback is for the at least one TB.

In a third aspect, there is provided a terminal device. The terminal device comprises a processing unit; and a memory coupled to the processing unit and storing instructions thereon, the instructions, when executed by the processing unit, causing the terminal device to perform the method according to the first aspect.

In a fourth aspect, there is provided a network device. The network device comprises a processing unit; and a memory coupled to the processing unit and storing instructions thereon, the instructions, when executed by the processing unit, causing the network device to perform the method according to the second aspect.

In a fifth aspect, there is provided a computer readable medium having instructions stored thereon, the instructions, when executed on at least one processor, causing the at least one processor to perform the method according to the first aspect.

In a sixth aspect, there is provided a computer readable medium having instructions stored thereon, the instructions, when executed on at least one processor, causing the at least one processor to perform the method according to the third aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 is a schematic diagram of a communication system in which embodiments of the present disclosure can be implemented;

FIG. 2 illustrates a signaling flow for communications in accordance with some embodiments of the present disclosure;

FIG. 3A illustrates an example scenario of TB transmission for terminal devices included in a multicast group in accordance with some embodiments of the present disclosure;

FIG. 3B illustrates an example scenario of TB transmission for terminal devices included in a multicast group in accordance with some other embodiments of the present disclosure;

FIG. 4 illustrates a further example scenario of TB transmission for terminal devices included in a multicast group in accordance with some embodiments of the present disclosure;

FIG. 5 is a flowchart of an example method implemented at a terminal device in accordance with some embodiments of the present disclosure;

FIG. 6 is a flowchart of an example method implemented at a network device in accordance with some embodiments of the present disclosure; and

FIG. 7 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device. In the following description, the terms “terminal device”, “communication device”, “terminal”, “user equipment” and “UE” may be used interchangeably.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band above 71 GHZ, frequency band larger than 100 GHz as well as Terahertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The network device may have the function of network energy saving, Self-Organising Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

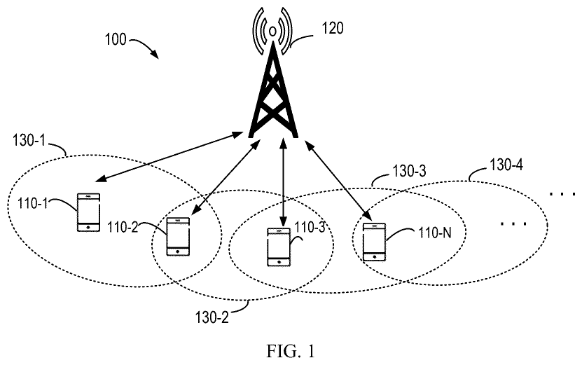

FIG. 1 illustrates a schematic diagram of a communication system in which embodiments of the present disclosure can be implemented. The communication system 100, which is a part of a communication network, comprises a terminal device 110-1, a terminal device 110-2, a terminal device 110-3, . . . , a terminal device 110-N, which can be collectively or individually referred to as “terminal device(s) 110.” The number N can be any suitable integer number. The numbers of terminal devices shown in FIG. 1 are given for the purpose of illustration without suggesting any limitations.

The communication system 100 further comprises a network device 120. In the communication system 100, the network device 120 and the terminal devices 110 can communicate data and control information with each other. In the communication system 100, a link from the network device 120 to a terminal device 110 is referred to as a downlink (DL), while a link from a terminal device 110 to the network device 120 is referred to as an uplink (UL). In DL, the network device 120 is a transmitting (TX) device (or a transmitter) and the terminal device 110 is a receiving (RX) device (or a receiver). In UL, the terminal device 110 is a TX device (or a transmitter) and the network device 120 is a RX device (or a receiver).

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHz, an extending NR operation up to 71 GHz, narrow band-Internet of Thing (NB-IOT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

The term “slot” used herein refers to a dynamic scheduling unit. One slot comprises a predetermined number of symbols. The slot used herein may refer to a normal slot which comprises a predetermined number of symbols and also refer to a sub-slot which comprises fewer symbols than the predetermined number of symbols.

In some embodiments, a terminal device 110 supports a unicast service and/or Multicast and Broadcast Service (MBS) with the network device 120.

According to the unicast service, the network device 120 may communicate with the terminal device 110 using a certain DL resource. In some embodiments, the communication from the network device 120 may occur in a certain DL resource, such as a Physical Downlink Shared Channel (PDSCH) occasion, and the corresponding reception at the terminal device 110 may be referred to as a candidate PDSCH reception for a unicast service. Such a PDSCH reception may also be referred to as a Group Common-PDSCH (GC-PDSCH).

MBS may include a multicast service and a broadcast service. For a multicast service, one or more multicast groups may be configured, each group comprising one or more than one terminal device 110. As an illustrated example, in FIG. 1, the terminal devices 110-1 and 110-2 may be included in a multicast group 130-1, the terminal devices 110-2, and 110-3 may be included in a multicast group 130-2, the terminal devices 110-3 and 110-N may be included in a multicast group 130-3, and the terminal device 110-N and possibly other terminal devices may be included in a multicast group 130-4. The multicast groups 130-1, 130-2, 130-3, 130-4 may be collectively or individually referred to as “multicast group(s) 130.”

In some cases, a terminal device 110 may be involved in two or more multicast groups for different multicast services. For example, in FIG. 1, the terminal device 110-2 is included in both the multicast groups 130-1 and 130-2, and the terminal device 110-3 is included in both the multicast groups 130-2 and 130-3. The network device 120 may communicate the same data with the terminal device(s) 110 in a same multicast group 130 using a certain DL resource. In some embodiments, the data transmission from the network device 120 may occur in a certain DL resource, such as a PDSCH occasion, and the corresponding reception at the terminal device 110 may be referred to as a PDSCH reception for a multicast service. The data transmission may include one or more transport blocks (TBs). That is, for each multicast groups, the network device 120 may transmit one or more TBs to the terminal device(s) 110 included therein. The network device 120 may transmit the same or different TBs to the terminal devices 110 included other multicast groups 130 using corresponding DL resources.

A TB(s) addressed to one multicast group may be scheduled over a channel, e.g., a Physical Downlink Control Channel (PDCCH) scrambled with a specific Group-Radio Network Temporary Identity (G-RNTI). Accordingly, a multicast group of terminal devices may be configured with a G-RNTI. Each terminal device 110 comprised in the multicast group may be configured with the G-RNTI to de-scramble the data transmitted by the network device 120 to the multicast group. In the case that a terminal device 110 is included in a plurality of multicast groups, the terminal device 110 may be configured with a plurality of G-RNTIs for the plurality of multicast groups.

In some embodiments, a Hybrid Automatic Repeat Request (HARQ) mechanism is applied in data communication between the network device 120 and the terminal devices 110. According to the HARQ mechanism, a receiver (e.g., the terminal device 110) may transmit a HARQ feedback to a transmitter (e.g., the network device 120) depending on whether a candidate reception of data from the transmitter is correctly detected by the receiver. Depending on the HARQ feedback, the transmitter may decide whether to perform a new transmission or a retransmission.

The HARQ feedback may be conveyed using a sequence and transmitted over a Physical Uplink Control Channel (PUCCH). The sequence is generated for a certain PUCCH format, including PUCCH format 0, PUCCH format 1, PUCCH format 1a, PUCCH format 1b, PUCCH format 2, PUCCH format 3, PUCCH format 4, and so on. Each PUCCH format may include sequences carrying a certain number of information bits.

For MBS, both a positive acknowledgement (ACK)/negative acknowledgement (NACK) based feedback mode and a NACK-only based feedback mode may be configured per G-RNTI (or per multicast group). In the ACK/NACK based feedback mode, a terminal device 110 may transmit an ACK feedback to the network device 120 if a TB from the network device is detected correctly, and transmit a NACK feedback if a TB is not correctly detected or missed. In the NACK-only based feedback mode, the terminal device 110 may transmit a NACK feedback only if a TB is not correctly detected or missed, and do not transmit an ACK feedback if all TBs are correctly detected.

For the NACK-only based feedback mode, it is still pending about how to transmit the NACK feedback for various combinations of TBs which are not correctly detected or missed. Unlike ACK/NACK based feedback which can be carried in any PUCCH format, the NACK-only based feedback may apply for certain PUCCH formats that can carry a limit number of information bits, such as PUCCH format 0 and PUCCH format 1 (which can carry no more than 2 bits). If the current mechanism is directly applied, the terminal device 110 may only be able to transmit NACK-only feedbacks for the combinations of up to two TBs within a slot.

Therefore, it is desired to design new mechanisms for transmitting NACK-only based feedback under the MBS.

According to embodiments of the present disclosure, there is provided a solution for NACK-only based feedback. In this solution, a terminal device determines that a negative acknowledgment (NACK) feedback is to be transmitted for at least one of a set of transport blocks (TBs) transmitted from a network device. The terminal device selects, from a mapping table associated with the set of TBs, a cyclic shift value (and/or an OCC) mapped to a combination of the at least one TB(s) The mapping table may indicate a mapping between different cyclic shift values (and/or different OCCs) and different combinations of TBs among the set of TBs. The terminal device generates a sequence at least based on the selected cyclic shift value (and/or the selected OCC) and transmits, to the network device, the NACK feedback for the at least one TB using the generated sequence.

At the network device side, the network device transmits a set of transport blocks (TBs) to at least one multicast group of terminal devices, and receives, from a terminal device, a negative acknowledgment (NACK) feedback using a sequence, the terminal device being comprised in the at least one multicast group. The network device decodes the sequence to obtain at least a cyclic shift value (and/or a OCC) used for generating the sequence; determining, from a mapping table associated with the set of TBs, a combination of at least one TB(s) mapped to the cyclic shift value (and/or the OCC). The mapping table may indicate a mapping between different cyclic shift values (and/or different OCCs) and different combinations of TBs among the set of TBs. The network device determines that the NACK feedback is for the at least one TB(s).

Through this solution, NACK feedbacks for different combinations of TBs may be transmitted by the terminal device and identified by the network device.

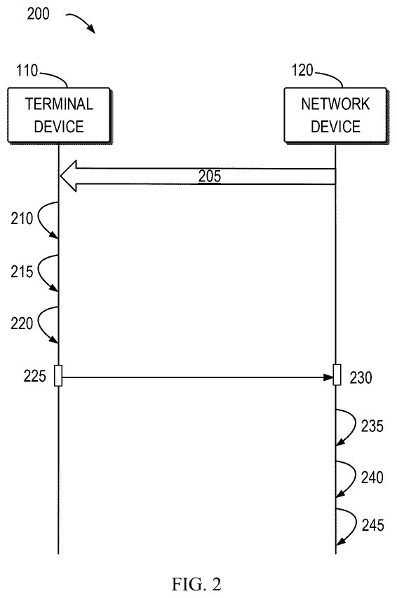

Embodiments of the present disclosure will be described in detail below. Reference is first made to FIG. 2, which shows a signaling flow 200 for communications between a terminal device and a network device according to those embodiments of the present disclosure.

Only for the purpose of discussion, the signaling flow 200 will be described with reference to FIG. 1. The signaling flow 200 may involve a terminal device 110 and the network device 120 in FIG. 1. Any of the terminal devices 110 in the environment 100 that supports multicast communication can be involved in the signaling flow 200. The terminal device 110 involved in the signaling flow 200 may be comprised in one or more of the multicast groups 130.

In the embodiments of the present disclosure, the terminal device 110 is configured with NACK-only feedback for HARQ communication with the network device. It is proposed to configure a mapping table for a set of TBs to be transmitted from the network device 120 to the terminal device 110. The mapping table indicates a mapping between different combinations of the set of TBs and one or more parameter values used to generate sequences for conveying a NACK feedback. Each of the different combinations of the TBs comprises one or more of TBs.

With the mapping, if any one, some or all of the sets of TBs are not detected correctly or missed, the terminal device 110 can select the mapped parameter value(s) to generate a sequence to indicate the NACK feedback. The network device 120 decodes the corresponding parameter value(s) from the received sequence and thus determines that a NACK feedback is for the combination of TBs. In other words, different parameter values used in generating the sequence are utilized to indicate the TB(s) for which the NACK feedback is transmitted by the terminal device 110. Depending on the PUCCH format used to generate the sequence, the parameter(s) concerned in the mapping table can be varied. The parameter(s) at least include a cyclic shift. The details will be discussed in the following.

Specifically, in the signaling flow 200, the network device 120 transmits 205 a set of TBs to at least one multicast group of terminal devices, including the terminal device 110 involved in the signaling flow 200. The set of TBs may include more than one TB. Each of the TBs may convey DL data or information to the terminal device 110.

In some embodiments, the set of TBs may include TBs for a same multicast group of terminal devices, and the terminal device 110 involved in the signaling flow 200 may be included in that multicast group. In this case, the set of TBs are scheduled by a Physical Downlink Control Channel (PDCCH) scrambled with a same G-RNTI. In some embodiments, the set of TBs may include TBs for a plurality of multicast groups of terminal devices, and the terminal device 110 involved in the signaling flow 200 may be included in each of the plurality of multicast groups. In this case, among the set of TBs, different sub-sets of TBs are scheduled by PDCCH scrambled with different G-RNTs. For example, the set of TBs comprising at least a first sub-set of TBs and a second sub-set of TBs. A first PDCH scheduling the first sub-set of TBs is scrambled with a first G-RNTI, a second PDCH scheduling the second sub-set of TBs is scrambled with a second G-RNTI different from the first G-RNTI, and so on.

It is noted that in addition to the set of TBs sent to the one multicast group or the plurality of multicast group including the terminal device 110 involved in the signaling flow 200, the network device 120 may further transmit TBs to one or more other multicast groups of terminal devices.

The terminal device 110 may receive and detect the sets of TBs from the network device 120 on the corresponding PDCCH. The terminal device 110 may utilize the G-RNTI(s) to de-scramble the PDCCH in order to detect the set of TBs. Depending on the channel conditions and/or other factors, the terminal device 110 may fail to detect or may miss at least one of the set of TBs. In this case, the terminal device 110 determines 210 that a NACK feedback is to be transmitted for the at least one TB transmitted from a network device 120.

To allow the network device 120 to know that the NACK feedback is transmitted for the specific at least one TB, the terminal device 110 relies on a mapping table associated with the set of TBs to generate a sequence and transmits the NACK feedback using the sequence.

The mapping table associated with the set of TBs indicates at least a mapping between at least different cyclic shift values and different combinations of TBs among the set of TBs. A cyclic shift is a parameter considered in generating a sequence, and different cyclic shift values may be used to generate different sequences. As used herein, a sequence is a resource in a code domain for PUCCH. A PUCCH resource may be related to a resource in the time domain, frequency domain, and code domain. As used herein, a combination of TBs may include one or more TBs. Two combinations of TBs are considered as different from each other if at least one TB included in one combination is not included in the other combination.

In the case that the set of TBs includes a plurality of TBs, in the NACK-only based feedback mode, the terminal device 110 may need to indicate the TB or TBs for which NACK is needed. In embodiments of the present disclosure, it is expected that different sequences correspond to different combinations of TBs among a set of TBs, so that the terminal device 110 can generate different sequences to indicate the NACK feedback for different combinations of TBs. Specifically, in the signaling flow 200, the terminal device 110 selects 215, from the mapping table associated with the set of TBs, a cyclic shift value mapped to a combination of the at least one TB for which a NACK feedback is determined to be transmitted. The terminal device 110 then generates 220 a sequence at least based on the selected cyclic shift value.

A sequence may be generated for various PUCCH formats, which may require different parameters including the cyclic shift. In some embodiments, in the NACK-only based feedback mode, the sequence used to convey the NACK feedback may be transmitted in one of PUCCH format 0 and PUCCH format 1, which can carry no more than 2 bits.

For better understanding, sequence generation for PUCCH format 0 and PUCCH format 1 is first introduced, which may also be found in 3GPP specification TS38.211.

For PUCCH format 0, a sequence x(n) shall be generated according to:

$$x ( l \cdot {N}_{sc}^{RB} + n ) = {r}_{u , v}^{( α , δ )} ( n ) \qquad Eq . ( 1 )$$

$$n = 0 , 1 , … , {N}_{sc}^{RB} - 1$$

$$l = \{ \begin{matrix}0 & for single - symbolPUCCH transmission \\ 0 , 1 & for double - symbolPUCCH transmission\end{matrix}$$

where r_{u,v}^{(α, δ)}(n) is given by clause 6.3.2.2 of 3GPP specification TS38.211, with m_{cs} depending on the information to be transmitted according to clause 9.2 of [5, TS 38.213].

The cyclic shift α varies as a function of the symbol and slot number according to

$${α}_{l} = \frac{2 π}{{N}_{sc}^{RB}} ( ( {m}_{0} + {m}_{cs} + {m}_{int} + {n}_{cs} ( {n}_{s , f}^{μ} , l + {l}^{′} ) ) mod {N}_{sc}^{RB} ) \qquad Eq . ( 2 )$$

where
n_{s,f}^{μ} is the slot number in the radio frame
l is the OFDM symbol number in the PUCCH transmission where l=0 corresponds to the first OFDM symbol of the PUCCH transmission,
l′ is the index of the OFDM symbol in the slot that corresponds to the first OFDM symbol of the PUCCH transmission in the slot given by [5, TS 38.213]
m₀ is given by [5, TS 38.213] for PUCCH format 0 and 1 while for PUCCH format 3 and 4 is defined in clause 6.4.1.3.3.1 of 3GPP specification TS38.211,
m_{cs}=0 except for PUCCH format 0 when it depends on the information to be transmitted according to clause 9.2 of [5, TS 38.213].
mᵢₙₜ is given by
   mᵢₙₜ=5n_{IRB}^{μ} for PUCCH formats 0 and 1 if PUCCH shall use interlaced mapping according to any of the higher-layer parameters useInterlacePUCCH-PUSCH in BWP-UplinkCommon or useInterlacePUCCH-PUSCH in BWP-UplinkDedicated, where n_{IRB}^{μ} is the resource block number within the interlace;
   mᵢₙₜ=0 otherwise

The function n_{cs}(n_{c}, l) is given by

$${n}_{cs} ( {n}_{s , f}^{μ} , l ) = {\sum }_{m = 0}^{7} {2}^{m} c ( 8 {N}_{symb}^{slot} {n}_{s , f}^{μ} + 8 l + m ) \qquad Eq . ( 3 )$$

where the pseudo-random sequence c(i) is defined by clause 5.2.1 of 3GPP specification TS38.211. The pseudo-random sequence generator shall be initialized with cᵢₙᵢₜ=n_{ID}, where n_{ID} is given by the higher-layer parameter hoppingId if configured, otherwise n_{ID}=N_{ID}^{cell}.

For PUCCH format 1, the complex-valued symbol d(0) shall be multiplied with a sequence r_{u,v}^{(α, δ)}(n) according to

$$y ( n ) = d ( 0 ) \cdot {r}_{u , v}^{( α , δ )} ( n ) \qquad Eq . ( 4 )$$

$$n = 0 , 1 , … , {N}_{sc}^{RB} - 1$$

where r_{u,v}^{(α, δ)}(n) is given by clause 6.3.2.2 of 3GPP specification TS38.211, where the cyclic shift α varies according to the function provided above. The block of complex-valued symbols y(0), . . . , y(N_{sc}^{RB}−1) shall be block-wise spread with the orthogonal sequence wᵢ(m) according to

$$z ( {m}^{′} {N}_{sc}^{RB} {N}_{SF , 0}^{PUCCH , 1} + {mN}_{sc}^{RB} + n ) = {w}_{i} ( m ) \cdot y ( n ) \qquad Eq . ( 5 )$$

$$n = 0 , 1 , … , {N}_{sc}^{RB} - 1$$

$$m = 0 , 1 , … , {N}_{SF , {m}^{′}}^{PUCCH , 1} - 1$$

$${m}^{′} = \{ \begin{matrix}0 & no intra - slot frequency hopping \\ 0 , 1 & intra - slot frequency hopping enabled\end{matrix}$$

where N_{SF,m′}^{PUCCH,1} is given by Table 6.3.2.4.1-1 of 3GPP specification TS38.211. Intra-slot frequency hopping shall be assumed when the higher-layer parameter intraSlotFrequencyHopping is provided, regardless of whether the frequency-hop distance is zero or not, and interlaced mapping is not enabled, otherwise no intra-slot frequency hopping shall be assumed.

The orthogonal sequence wᵢ(m) is given by Table 6.3.2.4.1-2 of 3GPP specification TS38.211, where i is the index of the orthogonal sequence to use according to clause 9.2.1 of [5, TS 38.213]. In case of a PUCCH transmission spanning multiple slots according to clause 9.2.6 of [5, TS38.213], the complex-valued symbol d (o) is repeated for the subsequent slots. For PUCCH format 1, a final sequence z is generated.

According to sequence generation for PUCCH format 0, the information conveyed by an orthogonal sequence is transmitted through a different cyclic shift value a, which varies at least based on specific values of cyclic shifts m₀ and m_{CS}. In some examples, there are 12 different cyclic shift values (by m_{CS}) that can be chosen to generate 12 different sequences. For a PUCCH resource configured with a certain time-frequency position for PUCCH format 0, it can extend to 12 orthogonal PUCCH resources by configured with different cyclic shift values, in which it can carry combinations of up to _{└}log₂ (12+1)_{┘}=3 TBs with NACK-only feedback at most.

According to sequence generation for PUCCH format 1, the information conveyed by an orthogonal sequence is transmitted through a different cyclic shift value α and/or a different orthogonal cover code (OCC) in the time domain. The OCC is used to define the orthogonal sequence wᵢ(m). That is, if at least one of the cyclic shift value a and the orthogonal sequence wᵢ(m), a different sequence z is generated for PUCCH format 1.

Theoretically, for a PUCCH resource configured with a certain time-frequency position for PUCCH format 1, this PUCCH resource can be multiplexed with 12 (by m_{CS})*7 (OCC in time domain)=84 terminal devices at most. Since PUCCH resources for NACK-only are group-common, if a group of terminal devices are scrambled by the same G-RNTI, there is no necessary to ensure the PUCCH resources from different terminal devices are orthogonal, thus these orthogonal PUCCH resources can be mapped to the different combinations of TBs with NACK-only feedback. It can carry combinations of up to _{└}log₂ (84+1)_{┘}=6 TBs with NACK-only feedback at most.

In embodiments of the present disclosure, the mapping table may be configured based on PUCCH format (e.g., PUCCH format 0 or PUCCH format 1). If the terminal device 110 is configured to support both PUCCH format 0 and PUCCH format 1, the terminal device 110 may determine which format is used. For different PUCCH formats, different mapping tables may be configured as associated with the corresponding PUCCH formats.

In some embodiments, the terminal device 110 may be configured in such a way that more than one NACK-only feedback corresponding to different G-RNTIs cannot be transmitted in the same slot for PUCCH (also referred to as PUCCH slot). In this case, the set of TBs may include TBs for the same G-RNTI. The terminal device 110 transmits a NACK feedback for a combination of TB(s) from the set of TBs within the PUCCH slot, as described below. If a further set of TBs for another G-RNTIs are transmitted from the network device 120, to convey a NACK feedback for a combination of TB(s) from the further set of TBs, the terminal device 110 may generate a sequence in a similar way as discussed above and transmit the NACK feedback using the generated sequence within another PUCCH slot. It is first described below some embodiments related to the configuration of disabling the terminal device 110 to transmit more than one NACK-only feedback corresponding to different G-RNTIs in a same PUCCH slot.

In some embodiments where the sequence is to be generated for PUCCH format 0, the mapping table associated with the set of transmitted TB may also be associated with PUCCH format 0. For PUCCH format 0, the mapping table may indicate a mapping between different cyclic shift values and different combinations of TBs among the set of TBs. In some embodiments, the cyclic shifts m₀ and m_{CS} used for sequence generation in Eq. (s) are considered for PUCCH format 0. Specifically, a cyclic shift value included in the mapping table is a sum of values of cyclic shifts m₀ and m_{CS}. Thus, a different cyclic shift value is mapped to a different combination of TB(s), to represent a NACK feedback for this combination of TB(s).

According to the current 3GPP specification, the information is carried by different values for m_{cs}, and multiple terminal devices may be multiplexed by configured with different UE-specific m₀. For the multicast service with NACK-only based feedback, due to there is no need to ensure the orthogonality among a group of terminal devices scrambled by the same G-RNTI, the orthogonal PUCCH resources (corresponding to different sequences) can represent different combinations of TBs with NACK-only feedback. Therefore, in some embodiments of the present disclosure, for NACK-only based feedback mode, it is proposed to use different sums of values of cyclic shifts m₀ and m_{CS} to generate different sequences, so as to represent different NACK feedbacks for different combination of TBs.

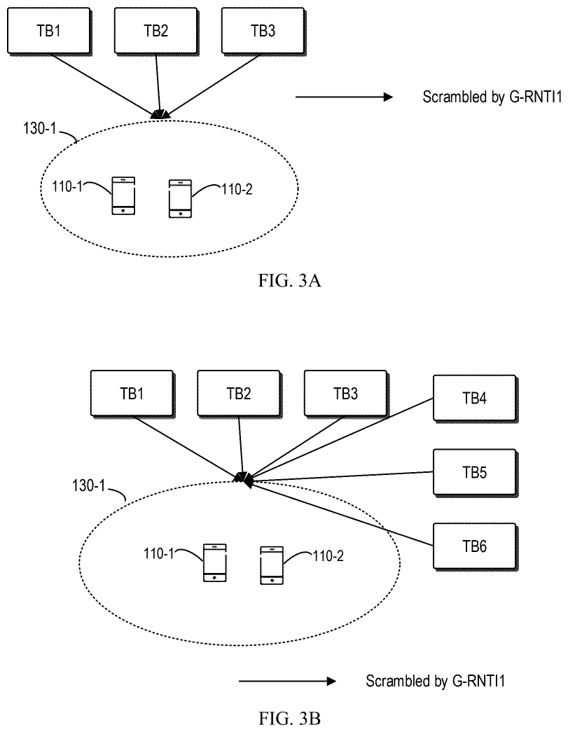

FIG. 3A illustrates an example scenario of TB transmission for terminal devices (e.g., terminal devices 110-1, 110-2) included in a multicast group (e.g., multicast group 130-1). In this example scenario, the network device 120 transmits TB1, TB2, TB3 to the multicast group 130-1. A PDCCH scheduling the three TB is scrambled with the same G-RNTI, e.g., G-RNTI1. At the side of each of the terminal devices 110-1, 110-2, it may fail to correctly detect or may miss any one, two, or all of the three TBs. There may be seven different combinations of TBs for which NACK feedbacks are to be transmitted, each of which may be mapped to a different sum of values of cyclic shifts m₀ and m_{CS}, as indicated below Mapping Table 1. In the solution proposed here, a sum of values of cyclic shifts m₀ and m_{CS} is referred to as a cyclic shift value in the mapping table and used to generate a sequence.

Mapping Table 1 associated with
three TBs and PUCCH format 0

| NACK-only | |
|---|---|
| feedback for | m₀ + m_{cs} |
| TB1 | 0 |
| TB2 | 1 |
| TB3 | 2 |
| TB1 and TB2 | 4 |
| TB1 and TB3 | 6 |
| TB2 and TB3 | 8 |
| TB1, TB2 and | 10 |
| TB3 | |

According to Mapping Table 1, if the terminal device 110-1 or 110-2 determines that a NACK feedback is to be transmitted for TB1 and TB2, it may select a cyclic shift value of “4” for the sum of m₀ and m_{CS}. Then the terminal device 110-1 or 110-2 may generate a sequence for PUCCH format 0 based on the selected cyclic shift value. The sequence generation for PUCCH format 0 may be performed in a similar way as described above.

It is noted that the values of a sum of cyclic shifts m₀ and m_{CS} provided in Mapping Table 1 is provided as an example. In some embodiments, the sum of cyclic shifts m₀ and m_{CS} may be varied in a range of [0, 11], meaning that there are 12 different values in the range [0, 11]. Thus, in some other examples, different values from the range of [0, 11] than those in Mapping Table 1 may be assigned to be mapped to different combinations of TBs.

In some embodiments, the set of TBs may be identified or indexed by a reception order of those TBs. Accordingly, the cyclic shift values mapped to different combinations of TBs may also be identified or indexed based on the reception order of the set of TBs. For example, in the example of FIG. 3A and Mapping Table 1, it is assumed that the three TBs are received in a sequential reception order of TB1, TB2, and TB3. In Mapping Table 1, mapping pairs of cyclic shift value and combination of TBs may be ordered based on the reception order of the three TBs and the number of TBs in each combination.

Generally, for two cyclic shift values with a relatively large difference, the sequences generated based on the two cyclic shift values may have relatively high orthogonality. In some embodiments, since the total number of different cyclic shift values (by m₀ and m_{CS}) is limited (e.g., 12 different values), to assign the cyclic shift values to different combinations of TBs, it is expected that a difference between cyclic shift values mapped to combinations each including more than one TB is large enough. For example, for a set including three TBs, the mapping table may be set in such a way that there is a relative large difference between any two of cyclic shift values mapped to a combination of TB1 and TB2, a combination of TB1 and TB3, a combination of TB2 and TB3, and a combination of TB1, TB2, and TB3. For example, in Mapping Table 1, the difference between cyclic shift values mapped any two of those combinations is larger than or equal to 2 (e.g., 4 mapped to the combination of TB1 and TB2, and 6 mapped to the combination of TB1 and TB3).

In some embodiments, a difference between any two of cyclic shift values mapped to combinations of single TBs may be relatively small, for example, smaller than the difference between cyclic shift values mapped to combinations including more than one TB. For example, in Mapping Table 1, the difference between cyclic shift values mapped the combination of TB1 and the combination of TB2 is 1, which is smaller than the difference between cyclic shift values mapped to the combination of TB1 and TB2 and the combination of TB1 and TB3.

In some embodiments, for a combination of more than one TB, it may be mapped to such a cyclic shift value that a difference between this cyclic shift value and any other cyclic shift value in the mapping table is larger than or equal to 2. For example, for the combination of TB1 and TB2, it is mapped to a cyclic shift value of 4, which has different from any other cyclic shift value in the Mapping Table 1, with a different of at least 2.

In some embodiments, it is assumed that the mapping table comprises a first cyclic shift value mapped to a combination of a first number of TBs, a second cyclic shift value mapped to a combination of a second number of TBs, and a third cyclic shift value mapped to a combination of a third number of TBs, where the first number is the largest one, i.e., larger than the second number and the third number. Then, the three cyclic shift values may be assigned in such a way that a difference (e.g., 3) between the first cyclic shift value (e.g., 4 for the combination of TB1 and TB2) and the second cyclic shift value (e.g., 1 for the combination of TB1) or a difference (e.g., 2) between the first cyclic shift value and the third cyclic shift value (e.g., 2 for the combination of TB2) is larger than a difference (e.g., 1) between the first cyclic shift value and the third cyclic shift value.

In some embodiments, in addition to the first, second, and third cyclic shift values, it is assumed that the mapping table further comprises a fourth cyclic shift value mapped to a combination of a fourth number of TBs, the first number and the second number each being larger than both the third number and the fourth number. Then, the four cyclic shift values may be assigned a difference (e.g., 2) between the first cyclic shift value (e.g., 4 for the combination of TB1 and TB2) and the second cyclic shift value (e.g., 6 for the combination of TB1 and TB3) is larger than a difference (e.g., 1) between the third cyclic shift value (e.g., 1 for the combination of TB1) and the fourth cyclic shift value (e.g., 2 for the combination of TB2).

In some embodiments, if the number of TBs considered for NACK feedback is different than three, a different mapping table may be configured for the different number of TBs. For example, if the network device 120 is about to transmit two TBs for a multicast group of terminal devices, then the terminal devices within this multicast group may be configured with a mapping table indicating a mapping between three different combinations of TBs and three different cyclic shift values, as indicated in below Mapping Table 2.

Mapping Table 2 associated with
two TBs and PUCCH format 0

| NACK-only | |
|---|---|
| feedback for | m₀ + m_{cs} |
| TB1 | 0 |
| TB2 | 2 |
| TB1 and TB2 | 4 |

The embodiments where the sequence is to be generated for PUCCH format 0 are discussed. In some embodiments where the sequence is to be generated for PUCCH format 0, the mapping table associated with the set of transmitted TB may also be associated with PUCCH format 1.

For PUCCH format 1, the mapping table may indicate a mapping between the different combinations of TBs, and different combinations of cyclic shift values and OCCs. Each combination of TBs is mapped to a different combination of a cyclic shift value and an OCC. The OCC is used to define the orthogonal sequence wᵢ(m) used for generating the sequence. Here, two combinations of cyclic shift values and OCCs are considered as different from each other if a cyclic shift value, an OCC, or both of them included in one combination is not included in the other combination.

In some embodiments, a total number of OCCs is 8, valued from a range of [0, 7]. As mentioned above, the total number of different cyclic shift values (sums of m₀ and m_{CS}) is 12, valued from a range of [0, 11]. In some embodiments, for two different OCCs, the sequences generated based on the two OCCs may have relatively high orthogonality. Therefore, when configuring the mapping table, the values of OCCs may be first varied with a higher priority than the cyclic shift values, to be mapped to different combinations of TBs.

Specifically, depending on the number of TBs in the set of TBs transmitted from the network device 120, a total number of different combinations of TBs may be different (for example, a total of seven combinations for a set of three TBs, and a total of 63 combinations for a set of six TBs). In some embodiments, in the case that the total number of the different combinations of TBs is less than or equal to the total number of different OCCs (e.g., 8), each combination of TBs may be mapped to a different OCC.

In this case, in some embodiments, the mapping table may include no cyclic shift value for the different combinations of TBs because the OCCs can represent different sequences (or different NACK feedbacks) for different combinations of TBs. In generating the sequence for PUCCH format 1, a default cyclic shift value or a cyclic shift value configured by the network device 120 may be used. In some other embodiments, in addition to the different OCCs, the mapping table may also include cyclic shift values mapped the different combinations of TBs. The cyclic shift values may be a same cyclic shift value (which may be default or configured by the network device 120), or may be different.

In the illustrated example scenario of FIG. 3A, it is assumed that the network device 120 transmits TB1, TB2, TB3 to the multicast group 130-1, and the terminal device 110 generate the sequence for PUCCH format 1. The total number of different TB combinations is seven. The mapping table may be configured as below.

Mapping Table 3 associated with
three TBs and PUCCH format 1

| NACK-only | | |
|---|---|---|
| feedback for | m₀ + m_{cs} | OCC |
| TB1 | 0 | 0 |
| TB2 | 0 | 1 |
| TB3 | 0 | 2 |
| TB1 and TB2 | 0 | 3 |
| TB1 and TB3 | 0 | 4 |
| TB2 and TB3 | 0 | 5 |
| TB1, TB2 and TB3 | 0 | 6 |

According to Mapping Table 3, if the terminal device 110-1 or 110-2 determines that a NACK feedback is to be transmitted for TB1 and TB2, it may select a cyclic shift value of “0” for the sum of m₀ and m_{CS} and an OCC of “3.” Then the terminal device 110-1 or 110-2 may generate a sequence for PUCCH format 1 based on the selected cyclic shift value and OCC. The sequence generation for PUCCH format 1 may be performed in a similar way as described above.

In the example of Mapping Table 3, different OCCs and the same cyclic shift value are mapped to the seven different combinations of TBs. It would be appreciated that the mapping in Mapping Table 3 is provide for the purpose of illustration only. In other embodiments, the OCCs may be assigned in other ways and the cyclic shift values may be omitted or may be set as different value(s).

In some embodiments, in the case that the total number of the different combinations of TBs is larger than the total number of different OCCs (e.g., 8), all the different OCCs may be first assigned to different combinations of TBs, and then different cyclic shift values may be assigned to the combinations of TBs so as to make sure that a combination of the OCC and the cyclic shift value is varied for different combinations of TBs. As a result, among all the different combinations of TBs, there may exist a number of combinations of TBs each mapped to a different OCC, and the number of such combinations of TBs is equal to the total number of different OCCs (e.g., 8). Of course, it is noted that a same OCC may be assigned to more than one combination of TBs if the total number of combinations of TBs is larger than the total number of different OCCs.

FIG. 3B illustrates another example scenario of TB transmission for terminal devices included (e.g., terminal devices 110-1, 110-2) in a multicast group (e.g., terminal devices 110-1, 110-2). In this example scenario, the network device 120 transmits TB1, TB2, TB3, TB4, TB5, TB6 to the multicast group 130-1. A PDCCH scheduling the three TB is scrambled with the same G-RNTI, e.g., G-RNTI1. At the side of each of the terminal devices 110-1, 110-2, the combinations of TBs for which NACK feedbacks are possibly transmitted may be relatively large, i.e., equal to 63. In this case, all the eight different OCCs may be assigned to different combinations of TBs, and then the cyclic shift values are also varied to allow that different combinations of OCCs and cyclic shift values are mapped to different combinations of TBs.

As an example, the mapping table associated with the six TBs may be configured as below.

Mapping Table 4 associated with
six TBs and PUCCH format 1

| NACK-only | | |
|---|---|---|
| feedback for | m₀ + m_{cs} | OCC |
| TB1 | 0 | 0 |
| TB2 | 0 | 1 |
| TB3 | 0 | 2 |
| TB1 and TB2 | 0 | 3 |
| TB1 and TB3 | 0 | 4 |
| TB1 and TB4 | 0 | 5 |
| TB1 and TB5 | 1 | 6 |
| TB1 and TB6 | 1 | 7 |
| . . . | . . . | . . . |
| TB5 and TB6 | 6 | 6 |
| . . . | . . . | . . . |
| All the six TBs | 11 | 6 |

According to Mapping Table 4, if the terminal device 110-1 or 110-2 determines that a NACK feedback is to be transmitted for TB5 and TB6, it may select a cyclic shift value of “1” for the sum of m₀ and m_{CS} and an OCC of “6.” Then the terminal device 110-1 or 110-2 may generate a sequence for PUCCH format 1 based on the selected cyclic shift value and OCC. The sequence generation for PUCCH format 1 may be performed in a similar way as described above. It would be appreciated that the mapping in Mapping Table 3 is provide for the purpose of illustration only. In other embodiments, the OCCs and cyclic shift values may be assigned in other ways.

In some embodiments, within the mapping table, there may be some combinations of TBs mapped to the same OCC. In this case, the cyclic shift values mapped to those combinations may be selected as having relatively large differences. In some embodiments, for some combinations of TBs mapped to different OCCs, the cyclic shift values mapped to those combinations may be selected as having relatively small differences or may even be the same. In particular, it is assumed that the mapping table comprises a first combination of a first cyclic shift value and a first OCC mapped to a first combination of TBs, a second combination of a second cyclic shift value and the first OCC mapped to a second combination of TBs, and a third combination of a third cyclic shift value and a second OCC mapped to a third combination of TBs. That is, the first combination of TBs and the second combination of TBs are mapped to the same first OCC, but the third combination of TBs is mapped to a different second OCC. In this case, a difference between the first cyclic shift value and the second cyclic shift value is larger than a difference between the first cyclic shift value and the third cyclic shift value.

In some embodiments, since the OCCs are first assigned to be mapped to the combinations of TBs, if the mapping table comprises a number of combinations of TBs mapped to a same OCC, different cyclic shift values are evenly selected from a total number of different cyclic shift values and then mapped to the number of combinations of TBs that are mapped to the same OCC. For example, cyclic shift values are valued from a range of [0, 11], and the different cyclic shift values are selected from this range such that a difference between any two consecutive selected cyclic shift values has substantially the same difference. In this way, it is possible to ensure highest orthogonality of the sequences generated for those combinations of TBs.

In Mapping Table 4, a combination of TB1 and TB5, a combination of TB5 and TB6, and a combination of all the six TBs are mapped to the same OCC of 6, then the cyclic shift values mapped to the three combinations of TBs are evenly selected from the range of [0, 11] as 1, 6, and 11. A difference between 1 and 6 is the same as a difference between 6 and 11.

In some embodiments, a different mapping table may be configured for a different number of TBs. For example, if the network device 120 is about to transmit four TBs for a multicast group of terminal devices and six TBs for another multicast group of terminal devices, two mapping tables may be defined. If a certain terminal device 110 is included in both the two multicast group, it may be configured with both the two mapping tables.

It should be appreciated that some examples for mapping the different combinations of cyclic shift values and OCCs to the different combinations of TBs are provided above. In other embodiments, the different combinations of cyclic shift values and OCCs may be mapped to the different combinations of TBs in other ways as long as a combination of a cyclic shift value and an OCC can be used to represent a NACK feedback for a combination of TBs.

As analyzed above, for a PUCCH resource configured with a certain time-frequency position for PUCCH format 0, it can extend to 12 orthogonal PUCCH resources by configured with different cyclic shift values, in which it can carry combinations of up to _{└}log₂(12+1)_{┘}=3 TBs with NACK-only feedback at most. For a PUCCH resource configured with a certain time-frequency position for PUCCH format 1, it can carry combinations of up to _{└}log₂(84+1)_{┘}=6 TBs with NACK-only feedback at most.

Accordingly, in some embodiments, if the terminal device 110 is configured to not transmit more than one NACK-only feedback corresponding to different G-RNTIs in a same PUCCH slot, for PUCCH format 0, the number of TBs for which the NACK feedback can be transmitted is less than or equal to 3; for PUCCH format 1, the number of TBs for which the NACK feedback can be transmitted is less than or equal to 6. In some embodiments, if the terminal device 110 is configured with both PUCCH format 0 and PUCCH format 1 for the NACK-only based feedback mode, the terminal device 110 may select whether PUCCH format 0 or PUCCH format 1 is used to generate the sequence based on the number of TBs for which the NACK feedback is to be transmitted.

In some examples, if the number of TBs for which the NACK feedback is less than or equal to three, the terminal device 110 may generate a sequence for PUCCH format 0 based on the selected cyclic shift value. In some examples, if the number of TBs for which the NACK feedback is larger than three and smaller than or equal to six, the terminal device 110 may generate a sequence for PUCCH format 0 based on the selected cyclic shift value.

In some embodiments, in the case that the terminal device 110 is configured with PUCCH format 1 only for the NACK-only based feedback mode, the terminal device 110 may generate a sequence for PUCCH format 1 based on the selected cyclic shift value if the number of TBs for which the NACK feedback is less than or equal to six.

In some embodiments described above, the terminal device 110 is configured to not transmit more than one NACK-only feedback corresponding to different G-RNTIs in a same PUCCH slot. In some other embodiments, the terminal device 110 may be configured in such a way that more than one NACK-only feedback corresponding to different G-RNTIs can be transmitted in the same slot for PUCCH (also referred to as PUCCH slot). In this case, the set of TBs may include TBs for different G-RNTIs. For example, the set of transmitted TBs may include TBs for a plurality of multicast groups of terminal devices, and the terminal device 110 involved in the signaling flow 200 may be included in each of the plurality of multicast groups. In this case, among the set of TBs, different sub-sets of TBs are scheduled by PDCCH scrambled with different G-RNTs. For example, the set of TBs comprising at least a first sub-set of TBs and a second sub-set of TBs.

In the embodiments where the terminal device 110 is allowed to transmit more than one NACK-only feedback corresponding to different G-RNTIs in a same PUCCH slot, within the mapping table associated with the set of TBs (which may associated with different G-RNTIs), different cyclic shift values (for PUCCH format 0) or different combinations of cyclic shift values and OCCs may be mapped to different combinations of TBs among the set of TB. For a certain terminal device 110, it may be able to generate a sequence to transmit the NACK feedback for any combination of TBs and transmit the NACK feedback within the same slot. As such, the terminal device 110 may generate different sequences for different combinations of TBs scrambled by different G-RNTI. At the side of the network device, it may also be able to identify the TB(s) for which multicast group scrambled by a certain G-RNTI(s) needs to be retransmitted.

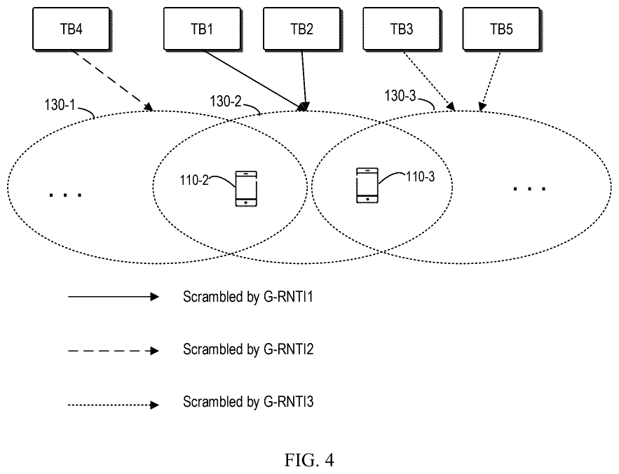

FIG. 4 illustrates an example scenario of TB transmission for terminal devices (e.g., terminal devices 110-2, 110-3) included in the multicast group 130-2. The terminal device 110-2 is also included in the multicast group 130-1, and the terminal device 110-3 is also included in the multicast group 130-3.

In this example scenario, the network device 120 transmits TB1 and TB2 to the multicast group 130-2, where PDCCH scheduling TB1 and TB2 is scrambled by G-RNTI1; the network device 120 transmits TB4 to the multicast group 130-1, where PDCCH scheduling TB4 is scrambled by G-RNTI2; the network device 120 also transmits TB3 and TB5 to the multicast group 130-3, where PDCCH scheduling TB3 and TB5 is scrambled by G-RNTI3.

At the side of the terminal device 110-2, it may need to receive TB1, TB2 for the multicast group 130-2 and receive TB4 for the multicast group 130-1. At the side of the terminal device 110-3, it may need to receive TB1, TB2 for the multicast group 130-2 and receive TB3 and TB5 for the multicast group 130-3. The terminal device 110-2 or 110-3 may fail to correctly detect or may miss any one, two, or all of the TBs it is supposed to receive. For the terminal device 110-2, for the three TBs (TB1, TB2, and TB4), it is supposed to receive, the mapping table associated with PUCCH format 0 may be configured as below.

Mapping Table 5 associated with three TBs
and PUCCH format 0

| NACK-only | | |
|---|---|---|
| feedback for | Scrambled by | m₀ + m_{cs} |
| TB1 | G-RNTI1 | 0 |
| TB2 | G-RNTI1 | 1 |
| TB4 | G-RNTI2 | 2 |
| TB1 and TB2 | G-RNTI1 | 4 |
| TB1 and TB4 | G-RNTI1/G-RNTI2 | 6 |
| TB2 and TB4 | G-RNTI1/G-RNTI2 | 8 |
| TB1, TB2 and TB4 | G-RNTI1/G-RNTI2 | 10 |

It is noted that the column of “Scrambled by” in Mapping Table 5 is show only to indicate the G-RNTI(s) related to the combination of TBs, and it may not be specifically included in the mapping table because both the terminal device 110 and the network device 130 may determine which TB is related to which G-RNTI.

According to Mapping Table 5, if the terminal device 110-2 determines that a NACK feedback is to be transmitted for TB1 and TB4 which are scheduled by PDCCH scrambled by different G-RNTI (e.g., G-RNTI1 and G-RNTI2), then the terminal device 110-2 select a cyclic shift value of “0” for generating a sequence for PUCCH format 0. The terminal device 110-2 may transmit the NACK feedback using the generated sequence within a same PUCCH slot. With such sequence generation, the network device 120, after decoding the sequence to obtain the cyclic shift value, it may be able to identify, from the same Mapping Table 5, that the NACK feedback is for TB1 and TB4.

For PUCCH format 1, the terminal device 110-2 may also be configured with a different mapping table for the three TBs and the mapping table may be configured in a similar way as discussed above for PUCCH format 1.

For the terminal device 110-3 which is supposed to receive four TBs, including TB1, TB2, TB3, and TB5, a mapping table associated with the four TBs and PUCCH format 1 may also be configured. This mapping table may be configured in a similar way as discussed above for PUCCH format 1.

In some embodiments, for both PUCCH format 0 and PUCCH format 1, and for both the cases where the terminal device 110 is allowed or disallowed to transmit more than one NACK-only feedback corresponding to different G-RNTIs in a same PUCCH slot, the network device 120 may configure the mapping table and notify the mapping table to the terminal device 110. In some embodiments, the network device 120 may configure one or more mapping tables associated with one or more different sets of TBs.

Generally, in current 3GPP specifications, for PUCCH format 0, a network device may transmit, to a terminal device, configuration information about PUCCH format 0, which at least indicate a UE-specific cyclic shift value for m₀. The terminal device may select the value for the cyclic shift m_{cs}. A traditional example structure of the configuration information is as below:

| | |
|---|---|
| PUCCH-format0 ::= | SEQUENCE { |
| initialCyclicShift | INTEGER(0..11), |
| nrofsymbols | INTEGER (1..2), |
| startingSymbolIndex | INTEGER(0..13) |
| } | |

where initialCyclichShift is used to set the value for m₀.

For PUCCH format 1, in addition to the UE-specific cyclic shift value for m₀ (initialCyclichShift), configuration information about PUCCH format 1 may further indicate an OCC for the terminal device. A traditional example structure of the configuration information is as below:

| | |
|---|---|
| PUCCH-format1 ::= | SEQUENCE { |
| initialCyclicshift | INTEGER(0..11), |
| nrofSymbols | INTEGER (4..14), |
| startingSymbolIndex | INTEGER(0..10), |
| timeDomainOCC | INTEGER(0..6) |
| } | |

where initialCyclichShift is used to set the value for m₀, and timeDomainOCC is used to set the OCC.

According to embodiments of the present disclosure as discussed above, for PUCCH format 0, it is the terminal device 110 which decide a sum of values of m₀ and m_{cs} based on which combination of TB(s) needs the NACK feedback. For PUCCH format 0, it is also the terminal device 110 which decide the OCC and possibly a sum of values of m₀ and m_{cs} based on which combination of TB(s) needs the NACK feedback.

Accordingly, in some embodiments of the present disclosure, for PUCCH format 0, the network device 120 may not need to configure the value for m₀ in the configuration information about PUCCH format 0; for PUCCH format 1, the network device 120 may not need to configure the OCC and the value for m₀ in the configuration information about PUCCH format 1. Therefore, the configuration information about PUCCH format 0 may indicate no cyclic shift value for the terminal device 110, and the configuration information about PUCCH format 1, the configuration information indicating no cyclic shift value and no OCC for the terminal device.

The structures of the configuration information about PUCCH format 0 and PUCCH format 1 may be changed as below:

```
PUCCH-format0 ::= SEQUENCE {

[symbol]

[symbol]

[symbol]

[symbol]

[symbol]

      nrofSymbols INTEGER (1..2), [symbol]
      startingSymbolIndex INTEGER(0..13) [symbol]
} [symbol]
PUCCH-format1 ::= SEQUENCE {

[symbol]

[symbol]

[symbol]

[symbol]

[symbol]

      nrofSymbols INTEGER (4..14), [symbol]
      startingSymbolIndex INTEGER(0..10),

[symbol]

[symbol]

[symbol]

[symbol]

} [symbol] [symbol]
indicates data missing or illegible when filed
```

where deleted text is shown in

[symbol]

Referring back to FIG. 2, in the signaling flow 200, after generating the sequence based on the selected cyclic shift value, the terminal device 110 transmits 225, to the network device 120, the NACK feedback for the at least one TB (which is not detected correctly or is missed by the terminal device 110) using the generated sequence. The terminal device 110 may transmit the NACK feedback using the generated sequence within a time slot.

As mentioned above, in some embodiments, the terminal device 110 may transmit the NACK feedback for the at least one TB which is scheduled by PDCCH scrambled with the same G-RNTI. In some embodiments, the terminal device 110 may transmit the NACK feedback for TBs which are scheduled by PDCCH scrambled with the different G-RNTIs.

At the side of the network device 120, it receives 230, from the terminal device 110, the NACK feedback using a sequence. The network device 120 decodes 235 the sequence to obtain at least a cyclic shift value used for generating the sequence.

The network device 120 further determines 240, from a mapping table associated with the set of transmitted TBs, a combination of at least one TB that is mapped to the cyclic shift value. The network device 120 may also be aware of the mapping table that is associated with the set of transmitted TBs. For PUCCH format 0, the cyclic shift value (the sum of m₀ and m_{CS}) may be used to find the mapped combination of at least one TB from the mapping table associated with PUCCH format 0. For PUCCH format 1, the network device 120 may decode the cyclic shift value and the OCC from the sequence and use the two values to find the mapped combination of at least one TB from the mapping table associated with PUCCH format 1.

With the combination determined, the network device 120 determines 245 that the NACK feedback is for the at least one TB. The network device 120 may also be able to determine that other TBs than the at least one TB are successfully received by the terminal device 110. According to the HARQ mechanism, the network device 120 may decide whether to retransmit the at least one TB for which the NACK feedback is received.

In some embodiments, from the perspective of the network device 120, it may receive, in a certain time slot, NACK feedbacks from a plurality of terminal devices included in the same multicast group or from different multicast groups. The network device 120 may be able to determine the specific TB(s) which is failed to be correctly detected by each of the terminal devices.

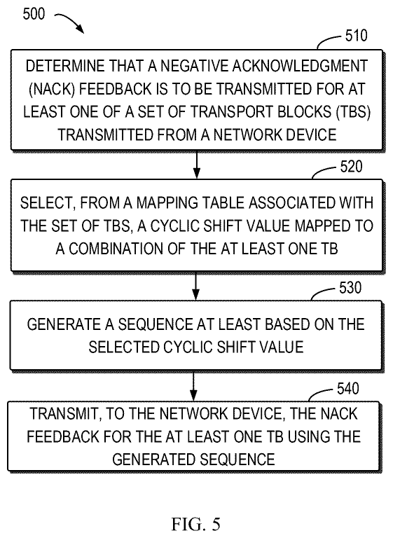

FIG. 5 is a flowchart of an example method 500 implemented at a terminal device in accordance with some embodiments of the present disclosure. For the convenience of discussion, the method 500 is described with reference to FIG. 1 and thus can be implemented by the terminal device 110.

At block 510, the terminal device 110 determines that a negative acknowledgment (NACK) feedback is to be transmitted for at least one of a set of transport blocks (TBs) transmitted from a network device. At block 520, the terminal device 110 selects, from a mapping table associated with the set of TBs, a cyclic shift value mapped to a combination of the at least one TB. In some embodiments, the mapping table indicates a mapping between at least different cyclic shift values and different combinations of TBs among the set of TBs.

At block 530, the terminal device 110 generates a sequence at least based on the selected cyclic shift value. At block 540, the terminal device 110 transmits, to the network device, the NACK feedback for the at least one TB using the generated sequence.

In some embodiments, the sequence is to be generated for Physical Uplink Control Channel (PUCCH) format 0, and the mapping table is associated with PUCCH format 0.

In some embodiments, a Physical Downlink Control Channel (PDCCH) scheduling the set of TBs is scrambled with a Group-Radio Network Temporary Identity (G-RNTI. In some embodiments, the mapping table comprises a first cyclic shift value mapped to a combination of a first number of TBs, a second cyclic shift value mapped to a combination of a second number of TBs, a third cyclic shift value mapped to a combination of a third number of TBs, and a fourth cyclic shift value mapped to a combination of a fourth number of TBs, the first number and the second number each being larger than both the third number and the fourth number. In some embodiments, a difference between the first cyclic shift value and the second cyclic shift value is larger than a difference between the third cyclic shift value and the fourth cyclic shift value.

In some embodiments, the mapping table comprises a fifth cyclic shift value mapped to a combination of more than one TB, a difference between the fifth cyclic shift value and any cyclic shift value in the mapping table is larger than or equal to 2.

In some embodiments, a PDCCH scheduling the set of TBs is scrambled with a G-RNTI. In this case, generating the sequence comprises: in accordance with a determination that the number of the at least one TB is less than or equal to three, generating a sequence for PUCCH format 0 based on the selected cyclic shift value.

In some embodiments, generating the sequence comprises: receiving, from the network device, configuration information about PUCCH format 0, the configuration information indicating no cyclic shift value for the terminal device; and generating the sequence based on the configuration information.

In some embodiments, the sequence is to be generated for PUCCH format 1. In some embodiments, the mapping table is associated with PUCCH format 1 and indicates a mapping between different combinations of TBs, and different combinations of cyclic shift values and orthogonal cover codes (OCCs), each combination of TBs being mapped to a different combination of a cyclic shift value and an OCC. In some embodiments, a combination of a cyclic shift value and an OCC mapped to a combination of the at least one TB is selected from the mapping table, and the sequence is generated based on the selected combination of the cyclic shift value and the OCC.

In some embodiments, in the case that a total number of combinations of TBs is less than or equal to a total number of OCCs, each combination of TBs is mapped to a combination of a cyclic shift value and a different OCC of the total numbers of OCCs.

In some embodiments, in the case that a total number of combinations of TBs is larger than a total number of OCCs, the total number of combinations of TBs comprises a first number of combinations of TBs each mapped to a combination of a cyclic shift value and a different OCC, the first number of combinations of TBs being equal to the total number of OCCs.

In some embodiments, a PDCCH scheduling the set of TBs is scrambled with a G-RNTI. In some embodiments, the mapping table comprises a second number of combinations of TBs mapped to a same OCC, and different cyclic shift values are evenly selected from a total number of cyclic shift values and mapped to the second number of combinations of TBs.

In some embodiments, a PDCCH scheduling the set of TBs is scrambled with a G-RNTI. In some embodiments, generating the sequence comprises: in accordance with a determination that the number of the at least one TB is less than or equal to six, generating a sequence for PUCCH format 1 based on the selected cyclic shift value.

In some embodiments, generating the sequence comprises: receiving, from the network device, configuration information about PUCCH format 1, the configuration information indicating no cyclic shift value and no OCC for the terminal device; and generating the sequence based on the configuration information.

In some embodiments, the set of TBs comprising at least a first sub-set of TBs and a second sub-set of TBs, a first PDCH scheduling the first sub-set of TBs is scrambled with a first G-RNTI, and a second PDCH scheduling the second sub-set of TBs is scrambled with a second G-RNTI different from the first G-RNTI.

In some embodiments, the set of TBs are indexed in the mapping table based on a reception order of the set of TBs.

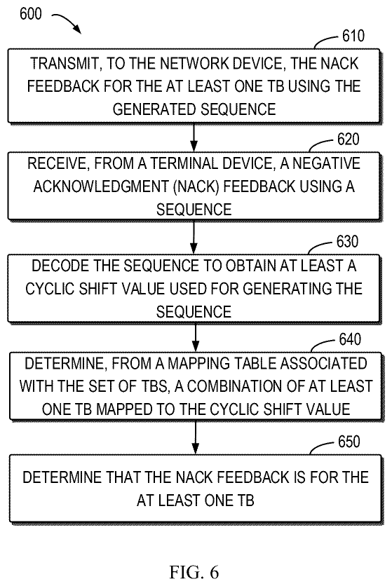

FIG. 6 is a flowchart of an example method 600 implemented at a network device in accordance with some embodiments of the present disclosure. For the convenience of discussion, the method 600 is described with reference to FIG. 1 and thus can be implemented by the network device 120.

At block 610, the network device 120 transmits a set of transport blocks (TBs) to at least one multicast group of terminal devices. At block 620, the network device 120 receives, from a terminal device, a negative acknowledgment (NACK) feedback using a sequence, the terminal device being comprised in the at least one multicast group. At block 630, the network device 120 decodes the sequence to obtain at least a cyclic shift value used for generating the sequence.

At block 640, the network device 120 determines, from a mapping table associated with the set of TBs, a combination of at least one TB mapped to the cyclic shift value. In some embodiments, the mapping table indicates a mapping between at least different cyclic shift values and different combinations of TBs among the set of TBs. At block 650, the network device 120 determines that the NACK feedback is for the at least one TB.

In some embodiments, the sequence is generated for Physical Uplink Control Channel (PUCCH) format 0, and the mapping table is associated with PUCCH format 0.

In some embodiments, a Physical Downlink Control Channel (PDCCH) scheduling the set of TBs is scrambled with a Group-Radio Network Temporary Identity (G-RNTI). In some embodiments, the mapping table comprises a first cyclic shift value mapped to a combination of a first number of TBs, a second cyclic shift value mapped to a combination of a second number of TBs, a third cyclic shift value mapped to a combination of a third number of TBs, and a fourth cyclic shift value mapped to a combination of a fourth number of TBs, the first number and the second number each being larger than both the third number and the fourth number. In some embodiments, a difference between the first cyclic shift value and the second cyclic shift value is larger than a difference between the third cyclic shift value and the fourth cyclic shift value.

In some embodiments, the mapping table comprises a fifth cyclic shift value mapped to a combination of more than one TB, a difference between the fifth cyclic shift value and any cyclic shift value in the mapping table is larger than or equal to 2.

In some embodiments, the method 600 further comprises transmitting, to the terminal device, configuration information about PUCCH format 0, the configuration information indicating no cyclic shift value for the terminal device.

In some embodiments, the sequence is generated for PUCCH format 1. In some embodiments, the mapping table is associated with PUCCH format 1 and indicates a mapping between different combinations of TBs and different combinations of both cyclic shift values and orthogonal cover codes (OCCs), each combination of TBs being mapped to a different combination of a cyclic shift value and an OCC. In some embodiments, the sequence is decoded to obtain a combination of a cyclic shift value and an OCC used for generating the sequence, and a combination of at least one TB mapped to the combination of a cyclic shift value and an OCC is determined from the mapping table.

In some embodiments, in the case that a total number of combinations of TBs is less than or equal to a total number of OCCs, each combination of TBs is mapped to a combination of a cyclic shift value and a different OCC of the total numbers of OCCs.

In some embodiments, in the case that a total number of combinations of TBs is larger than a total number of OCCs, the total number of combinations of TBs comprises a first number of combinations of TBs each mapped to a combination of a cyclic shift value and a different OCC, the first number of combinations of TBs being equal to the total number of OCCs.

In some embodiments, a PDCCH scheduling the set of TBs is scrambled with a G-RNTI. In some embodiments, the mapping table comprises a second number of combinations of TBs mapped to a same OCC, and different cyclic shift values are evenly selected from a total number of cyclic shift values and mapped to the second number of combinations of TBs.

In some embodiments, the method 600 further comprises transmitting, to the terminal device, configuration information about PUCCH format 1, the configuration information indicating no cyclic shift value and no OCC for the terminal device.

In some embodiments, the set of TBs comprising at least a first sub-set of TBs and a second sub-set of TBs, a first PDCH scheduling the first sub-set of TBs is scrambled with a first G-RNTI, and a second PDCH scheduling the second sub-set of TBs is scrambled with a second G-RNTI different from the first G-RNTI.

In some embodiments, the set of TBs are indexed in the mapping table based on a reception order of the set of TBs.

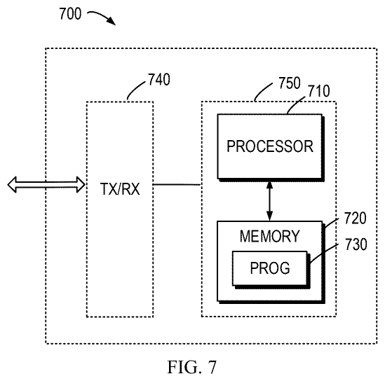

FIG. 7 is a simplified block diagram of a device 700 that is suitable for implementing embodiments of the present disclosure. The device 700 can be considered as an example implementation of the terminal device 110 or the network device 120 as shown in FIG. 1. Accordingly, the device 700 can be implemented at or as at least a part of the terminal device 110 or the network device 120.

As shown, the device 700 includes a processor 710, a memory 720 coupled to the processor 710, a suitable transmitter (TX) and receiver (RX) 740 coupled to the processor 710, and a communication interface coupled to the TX/RX 740. The memory 720 stores at least a part of a program 730. The TX/RX 740 is for bidirectional communications. The TX/RX 740 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 730 is assumed to include program instructions that, when executed by the associated processor 710, enable the device 700 to operate in accordance with the embodiments of the present disclosure, as discussed herein with reference to FIGS. 2 to 6. The embodiments herein may be implemented by computer software executable by the processor 710 of the device 700, or by hardware, or by a combination of software and hardware. The processor 710 may be configured to implement various embodiments of the present disclosure. Furthermore, a combination of the processor 710 and memory 720 may form processing means 750 adapted to implement various embodiments of the present disclosure.

The memory 720 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 720 is shown in the device 700, there may be several physically distinct memory modules in the device 700. The processor 710 may be of any type suitable to the local technical network, and may include one or more of general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 to 10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-32. (canceled)

33. A method, performed by a terminal device, the method comprising:
receiving a configuration of a negative acknowledgement (NACK)-only based feedback mode, and
transmitting, to a network device, a physical uplink control channel (PUCCH) to provide one or more information bits associated with hybrid automatic repeat request (HARQ) feedback by selecting a PUCCH resource from a plurality of PUCCH resources based on a value corresponding to the one or more information bits according to a mapping table for the NACK-only based feedback mode,
wherein all PUCCH resources in the plurality of PUCCH resources associated with the NACK-only based feedback mode have a same starting time position.

34. The method of claim 33, wherein
the one or more information bits comprise at least one NACK value.

35. The method of claim 33, wherein
the PUCCH is not transmitted in a case where the one or more information bits are all ACK values.

36. The method of claim 33, wherein
the mapping table indicates a mapping of values corresponding to the one or more information bits to the plurality of PUCCH resources for the NACK-only based feedback mode.

37. A method, performed by a network device, the method comprising:
transmitting a configuration of a negative acknowledgement (NACK)-only based feedback mode, and
receiving, from a terminal device, a physical uplink control channel (PUCCH),
wherein the PUCCH is used to provide one or more information bits associated with hybrid automatic repeat request (HARQ) feedback by selecting a PUCCH resource from a plurality of PUCCH resources based on a value corresponding to the one or more information bits according to a mapping table for the NACK-only based feedback mode,
wherein all PUCCH resources in the plurality of PUCCH resources associated with the NACK-only based feedback mode have a same starting time position.

38. The method of claim 37, wherein
the one or more information bits comprise at least one NACK value.

39. The method of claim 37, wherein
the PUCCH is not transmitted in a case where the one or more information bits are all ACK values.

40. The method of claim 37, wherein
the mapping table indicates a mapping of values corresponding to the one or more information bits to the plurality of PUCCH resources for the NACK-only based feedback mode.

41. A terminal device, comprising a processor configured to cause the terminal device to:
receive a configuration of a negative acknowledgement (NACK)-only based feedback mode, and
transmit, to a network device, a physical uplink control channel (PUCCH) to provide one or more information bits associated with hybrid automatic repeat request (HARQ) feedback by selecting a PUCCH resource from a plurality of PUCCH resources based on a value corresponding to the one or more information bits according to a mapping table for the NACK-only based feedback mode,
wherein all PUCCH resources in the plurality of PUCCH resources associated with the NACK-only based feedback mode have a same starting time position.

42. The terminal device of claim 41, wherein
the one or more information bits comprise at least one NACK value.

43. The terminal device of claim 41, wherein
the PUCCH is not transmitted in a case where the one or more information bits are all ACK values.

44. The terminal device of claim 41, wherein
the mapping table indicates a mapping of values corresponding to the one or more information bits to the plurality of PUCCH resources for the NACK-only based feedback mode.
